(19) United States
(12) Patent Application Publication
(10) Pub. No.: US 2014/0333399 A1
(43) Pub. Date: Nov. 13, 2014

(54) PSEUDO MECHANICAL ENERGY GENERATOR

(71) Applicant: Franklin Limberg, Rogers, AR (US)

(72) Inventor: Franklin Limberg, Rogers, AR (US)

(21) Appl. No.: 13/889,834

(22) Filed: May 8, 2013

(51) Int. Cl. H01F 30/12

(52) U.S. Cl. CPC H01F 30/12; H02N 11/008
USPC 336/12; 74/DIG. 9

(57) ABSTRACT

An electrical generator including a ring shaped coil and a plurality of magnets attached to the ring shaped coil. The magnets may be operatively connected to a power supply. A controller may be connected to the power supply to turn the magnets on and off. The magnets may be turned on and off sequentially around the ring shaped coil to generate electricity.

### BACKGROUND OF THE INVENTION

The present invention relates to an electromagnetic energy generator and, more particularly, to an electromagnetic energy generator that includes a ring shaped coil with magnets attached.

In electricity generation, an electric generator is a device that converts mechanical energy to electrical energy. A generator forces electric current to flow through an external circuit. The source of mechanical energy may be a reciprocating or turbine steam engine, water falling through a turbine or waterwheel, an internal combustion engine, a wind turbine, a hand crank, compressed air, or any other source of mechanical energy. Generators provide nearly all of the power for electric power grids.

Historically, mechanical energy is needed to produce electricity, either by spinning the wires or coil around a magnetic field, or by spinning the magnetic field or magnets around the coil. A direct current generator draws current from wires spinning around a magnetic field. Other generators create a charge by spinning a magnetic field or magnets inside a metal coil. However, current generators may be expensive, inefficient, or produce a lot of pollutants. Further, the use of mechanical energy wastes energy in the form of friction and heat.

As can be seen, there is a need for an efficient and non-pollutant generator.

### SUMMARY OF THE INVENTION

In one aspect of the present invention, a generator comprises: a coil in the shape of a ring; a plurality of electromagnets attached to the coil; a power supply operatively connected to the plurality of magnets; and a controller operatively connected to the power supply, wherein the controller turns on and off each individual magnet.

In another aspect of the present invention, a method of producing electricity comprises: providing a generator comprising: a coil in the shape of a ring; a plurality of electromagnets attached to the coil around the ring; a power supply operatively connected to the plurality of magnets; and a controller operatively connected to the power supply, wherein the controller turns on and off each individual magnet; and turning on and off the plurality of magnets sequentially around the coil.

In another aspect of the present invention, a method of producing electricity comprises: providing a generator comprising: a coil in the shape of a ring; a plurality of electromagnets comprising a first magnet and a second magnet attached to the coil; a power supply operatively connected to the plurality of magnets; and a controller operatively connected to the power supply, wherein the controller turns on and off each individual magnet; turning on the first magnet; turning on the second magnet; turning off the first magnet; turning off the second magnet; and repeating the above steps starting with turning on the first magnet.

In another aspect of the present invention, a method of producing electricity comprises: providing a generator comprising: a coil in the shape of a ring; a plurality of electromagnets comprising a first magnet, a second magnet, and a third magnet attached to the coil; a power supply operatively connected to the plurality of magnets; and a controller operatively connected to the power supply, wherein the controller turns on and off each individual magnet; turning on the first magnet; turning on the second magnet; turning off the first magnet; turning on the third magnet; turning off the second magnet; turning on the first magnet; turning off the third magnet; and repeating the above steps starting with turning on the second magnet.

In another aspect of the present invention a method of producing electricity comprises: providing a generator comprising: a coil in the shape of a ring; a plurality of electromagnets comprising a first magnet, a second magnet, a third magnet, a fourth magnet, and a fifth magnet attached to the coil; a power supply operatively connected to the plurality of magnets; and a controller operatively connected to the power supply, wherein the controller turns on and off each individual magnet; turning on the first magnet; turning on the second magnet; turning off the first magnet; turning on the third magnet; turning off the second magnet; turning on the fourth magnet; turning off the third magnet; turning on the fifth magnet; turning off the fourth magnet; turning on the first magnet; turning off the fifth magnet; and repeating the above steps starting with turning on the second magnet.

These and other features, aspects and advantages of the present invention will become better understood with reference to the following drawings, description and claims.

### BRIEF DESCRIPTION OF THE DRAWINGS

FIG. 1 is a perspective view of the device of the present invention;

FIG. 2 is a flowchart of a method of generating power using the device of FIG. 1; and

FIG. 3 is a continuation of the flowchart of FIG. 2.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an electrical generator including a ring shaped coil and a plurality of magnets attached to the ring shaped coil. The magnets may be operatively connected to a power supply and a controller may be connected to the power supply to turn the magnets on and off. The magnets may be turned on and off sequentially around the ring shaped coil to generate electricity.

The present invention may include a device in which the charge may move with relation to a coil without having to move either the coil or the magnet(s) to generate electricity. The device may include having a series of electromagnets around the coil and turning on and off one or more of the electromagnets in sequence to move the charge around the coil. By using the electromagnets in sequence there is no need for mechanical energy.

Optionally the size of the coil and number of electromagnets used may be changed to suit the needs of the generator. The number of electromagnets switched on at one time may be increased to one less than the total number of electromagnets in the system, where as the electromagnet that is off in the system is systematical moved around the coil. The power supply may be by any means, such as a battery.

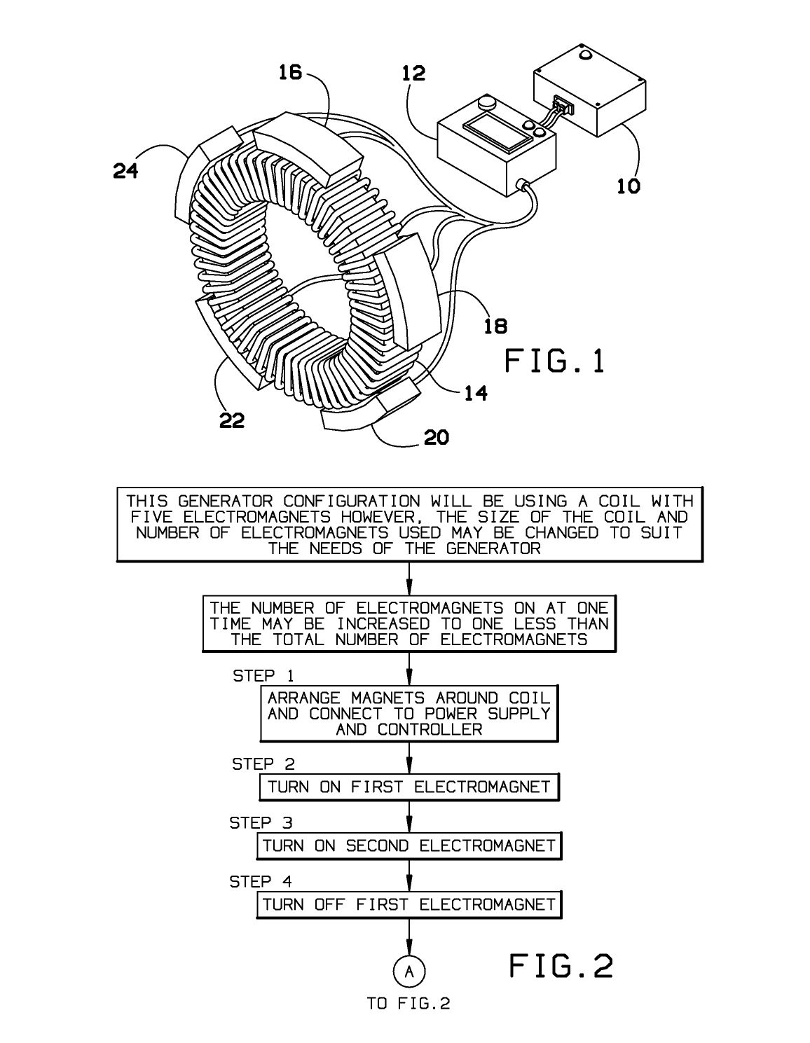

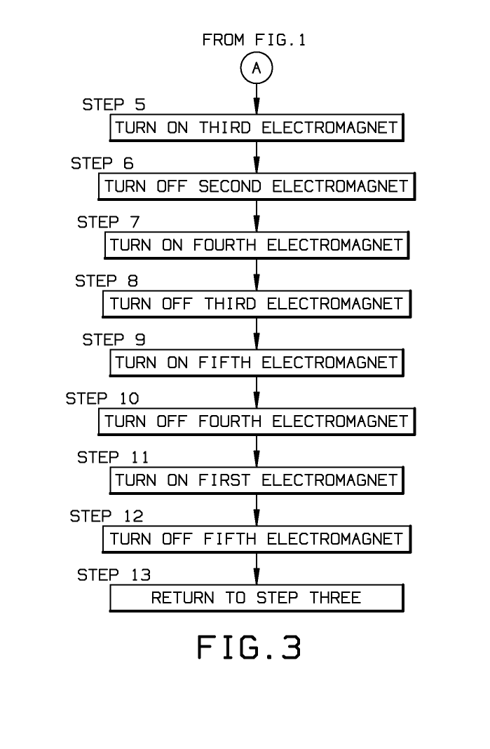

Referring to FIGS. 1 and 2, the present invention may include a coil 14. The coil 14 may be in the shape of a ring, such as a torus shape. Electromagnets may be attached around the coil 14. In certain embodiments, the electromagnets may be evenly spaced around the coil 14 as illustrated in FIG. 1. The present invention may include as little as two, three, four or five electromagnets and up to as many as desired. FIG. 1 illustrates the coil 14 comprising five electromagnets. The five electromagnets may include a first magnet 16, a second magnet 18, a third magnet 20, a fourth magnet 22, and a fifth magnet 24.

A power supply 10 may be operatively connected to each electromagnet. The power supply 10 may charge the electromagnet. A controller 12 may connect the power supply 10 to the electromagnets. The controller 12 may control the charge of each electromagnet connected to the coil 14. Therefore, the control 12 may turn on and off the electromagnet when necessary. The magnets may be turned on and off sequentially around the coil.

A method of using the present invention may include the following. The first magnet 16 may be turned on; the second magnet 18 may be turned on; the first magnet 16 may be turned off; the third magnet 20 may be turned on; the second magnet 18 may be turned off; the fourth magnet 22 may be turned on; the third magnet 20 may be turned off; the fifth magnet 24 may be turned on; the fourth magnet 22 may be turned off; and then repeat the following steps to generate electricity.

The present invention may include at least two magnets. If the present invention uses two magnets the method may include the following: the first magnet 16 may be turned on; the second magnet 18 may turned on; the first magnet 16 may be turned off; the second magnet 18 may be turned off, and these steps may be continuously repeated.

The present invention may include at least three magnets. If the present invention uses three magnets the method may include the following: the first magnet 16 may be turned on; the second magnet 18 may turned on; the first magnet 16 may be turned off; the third magnet 20 may be turned on; the first magnet 16 may be turned on; and these steps may be continuously repeated.

It should be understood, of course, that the foregoing relates to exemplary embodiments of the invention and that modifications may be made without departing from the spirit and scope of the invention as set forth in the following claims.

1. A generator comprising:
a coil in the shape of a ring;
a plurality of electromagnets attached to the coil;
a power supply operatively connected to the plurality of magnets; and
a controller operatively connected to the power supply, wherein the controller turns on and off each individual magnet.

2. The generator of claim 1, wherein the plurality of electromagnets is selected from the group consisting of two magnets, three magnets, four magnets, and five magnets.

3. A method of producing electricity comprising:
providing a generator comprising:
a coil in the shape of a ring;
a plurality of electromagnets attached to the coil;
a power supply operatively connected to the plurality of magnets; and
a controller operatively connected to the power supply,
wherein the controller turns on and off each individual magnet; and
turning on and off the plurality of magnets sequentially around the coil.

4. The method of claim 3 On wherein the number of electromagnets switched on at one time is increased to up to one less than the total number of electromagnets.

5. (canceled)

6. (canceled)

7. (canceled)

8. (canceled)

9. The method of claim 3, wherein the plurality of electromagnets comprises a first magnet and a second magnet attached to the coil.

10. The method of claim 9, further comprising the steps of:
turning on the first magnet;
turning on the second magnet;
turning off the first magnet;
turning off the second magnet; and
repeating the above steps starting with turning on the first magnet.

11. The method of claim 3, wherein the plurality of electromagnets comprises a first magnet, a second magnet, and a third magnet attached to the coil.

12. The method of claim 11, further comprising the steps of:
turning on the first magnet;
turning on the second magnet;
turning off the first magnet;
turning on the third magnet;
turning off the second magnet;
turning on the first magnet;
turning off the third magnet; and
repeating the above steps starting with turning on the second magnet.

13. The method of claim 3, wherein the plurality of electromagnets comprises a first magnet, a second magnet, a third magnet, a fourth magnet, and a fifth magnet attached to the coil.

14. The method of claim 13, further comprising the steps of:
turning on the first magnet;
turning on the second magnet;
turning off the first magnet;
turning on the third magnet;
turning off the second magnet;
turning on the fourth magnet;
turning off the third magnet;
turning on the fifth magnet;
turning off the fourth magnet;
turning on the first magnet;
turning off the fifth magnet;
repeating the above steps starting with turning on the second magnet.

15. The method of claim 14, wherein the number of electromagnets switched on at one time is increased to up to four of the magnets.
